(19) United States
(12) Patent Application Publication
(10) Pub. No.: US 2026/0162492 A1
(43) Pub. Date: Jun. 11, 2026

(54) KENO STRUCTURES FOR CENTRAL DETERMINATION SYSTEMS

(71) Applicant: IGT, Las Vegas, NV (US)

(72) Inventors: Nicholas Jon Scheffel, Reno, NV (US); Daniel Robert Tooker, Reno, NV (US)

(21) Appl. No.: 18/977,374

(22) Filed: Dec. 11, 2024

(51) Int. Cl. G07F 17/32

(52) U.S. Cl. CPC G07F 17/323; G07F 17/329

(57) ABSTRACT

Gaming systems and methods of operation thereof that include a central determination system and electronic gaming machines configured to provide plays of keno games.

### BACKGROUND

The present disclosure relates to keno structures for central determination systems in a gaming environment.

Gaming machines may provide a player an award based on obtaining a winning symbol combination. Gaming machines may provide a player an award based on a predetermined award amount provided by a historical horse race system or other central determination system.

### BRIEF SUMMARY

In various embodiments, the present disclosure relates to a gaming system including an electronic gaming machine configured to communicate with a central determination system central server. The electronic gaming machine includes a display device, a processor, and a memory device that stores a plurality of instructions that, when executed by the processor, cause the processor to: cause a display, by the display device, of a keno board comprising a first quantity of spots, cause a display, by the display device, of indications of a second quantity of player spots, the second quantity being less than the first quantity, cause a display, by the display device, of an indication of a first amount associated with the second quantity of player spots, the first amount being one of a plurality of different possible amounts, and receive data indicating a first award amount from the central determination system central server, the first award amount selected by the central determination system central server from a first sub-pool associated with the second quantity and the first amount, wherein the first sub-pool comprises a plurality of different award amounts comprising the first award amount and a different second award amount. The plurality of instructions, when executed by the processor, further cause the processor to: based on the first award amount, determine a third quantity of spots that each match a different one of the second quantity of player spots, based on the first award amount, determine a fourth quantity of spots that do not match any of the second quantity of player spots, cause a display, by the display device, of indications of each of the third quantity of spots and the fourth quantity of spots as drawn spots, and cause a display, by the display device, of an indication of the award amount based on the drawn spots and the player spots.

In various other embodiments, the present disclosure relates to a gaming system including an electronic gaming machine comprising a display device, a processor, and a memory device that stores a plurality of instructions that, when executed by the processor, cause the processor to: cause a display, by the display device, of a keno board comprising a first quantity of spots, cause a display, by the display device, of indications of a second quantity of player spots, the second quantity being less than the first quantity, and cause a display, by the display device, of an indication of a first amount associated with the second quantity of player spots, the first amount being one of a plurality of different possible amounts. The gaming system also includes a central determination system central server comprising a processor and a memory device that stores a plurality of instructions that, when executed by the processor, cause the processor to: receive data indicating the second quantity and the first amount from the electronic gaming machine, determine a first award amount selected from a first sub-pool associated with the second quantity and the first amount, the first sub-pool comprising a plurality of different award amounts including the first award amount and a different second award amount, and send data indicating the first award amount to the electronic gaming machine. The plurality of instructions stored by the memory device of the electronic gaming machine, when executed by the processor of the electronic gaming machine, further cause the processor of the electronic gaming machine to: based on the first award amount, determine a third quantity of spots that each match a different one of the player spots, determine a fourth quantity of spots that do not match any of the player spots, cause a display, by the display device, of an indication of the each of the third quantity of spots and the fourth quantity of spots, and cause a display, by the display device, of an indication of the first award amount.

In various other embodiments, the present disclosure relates to a gaming system including a central server configured to communicate with an electronic gaming machine. The central server comprises a processor and a memory device that stores a plurality of instructions that, when executed by the processor, cause the processor to: receive data from the electronic gaming machine indicating: a second quantity of player spots of a keno board selected from a first quantity of player spots of the keno board, the first quantity being greater than the second quantity, and a first amount associated with the second quantity of player spots, select a first sub-pool from a plurality of different sub-pools, where each of the sub-pools is associated with a different combination of quantity of player spots and an associated amount, wherein the first sub-pool is associated with the second quantity and the first amount, and determine a first award amount selected from the first sub-pool, the first sub-pool comprising a plurality of different award amounts including the first award amount and a different second award amount. The plurality of instructions, when executed by the processor, further cause the processor to: send data indicating the first award amount to the electronic gaming machine to enable the electronic gaming machine to: based on the first award amount, determine a third quantity of spots that each match a different one of the player spots, determine a fourth quantity of spots that do not match any of the player spots, cause a display, by a display device of the electronic gaming machine, of an indication of each of the third quantity of spots and the fourth quantity of spots, and cause a display, by the display device of the electronic gaming machine, of an indication of the first award amount.

Additional features are described herein, and will be apparent from the following Detailed Description and the figures.

### BRIEF DESCRIPTION OF THE SEVERAL VIEWS OF THE DRAWINGS

FIG. 1 is diagrammatic view of a gaming system including an electronic gaming machine and a central determination system central server in accordance with one example embodiment of the present disclosure.

FIG. 2 is an example keno game paytable employed by the electronic gaming machine of the gaming system of FIG. 1 in accordance with one example embodiment of the present disclosure.

FIG. 3 is part of an example keno structure including a keno game pool set maintained by the central determination system central server of the gaming system of FIG. 1 in accordance with one example embodiment of the present disclosure.

FIG. 4 is a flowchart showing a method of operating the gaming system of FIG. 1 in accordance with one example embodiment of the present disclosure.

FIG. 5 illustrates an example method of operating the gaming system of FIG. 1 to provide an example play of a keno game in accordance with one example embodiment of the present disclosure.

FIG. 6 illustrates part of a first example alternative keno game with an additional feature.

FIG. 7 illustrates an example method of operating the gaming system of the present disclosure to provide an example play of the alternative keno game of FIG. 6 in accordance with one example embodiment of the present disclosure.

FIG. 8 illustrates part of a second example alternative keno game with an additional feature.

FIG. 9 illustrates an example method of operating the gaming system of the present disclosure to provide an example play of the alternative keno game of FIG. 8 in accordance with one example embodiment of the present disclosure.

FIG. 10 is a schematic block diagram of one example embodiment of an electronic configuration of an example electronic gaming machine of the game system of the present disclosure.

FIGS. 11A and 11B are perspective views of example alternative embodiments of the electronic gaming machines of the gaming system disclosed herein.

FIG. 11C is a front view of an example personal gaming device of the gaming system of one example embodiment of the present disclosure.

### DETAILED DESCRIPTION

In various embodiments, the present disclosure relates to gaming systems and methods of operating gaming systems that provide keno games in a central determination system gaming environment. In various embodiments, the gaming system includes a central determination system central server configured to communicate with electronic gaming machines of the gaming system, wherein the electronic gaming machines are configured to provide plays of keno games, and wherein the award amounts for the plays of the keno games are determined by the central determination system central server and provided to the electronic gaming machines.

The following background regarding central determination systems is provided for a better understanding of the present disclosure.

Various gaming machines randomly generate symbols and display those symbols as outcomes of plays of the games on such gaming machines. For purposes of this disclosure, the terms random or randomly can include a pseudo random determination. Various gaming machines include a relatively low probability associated with obtaining the highest award, relatively medium probabilities associated with obtaining medium range awards, and relatively higher probabilities associated with obtaining low range awards or awards of zero. For purposes of the present disclosure, the term award can include an award of zero credits or $0.00. The probabilities of obtaining the various awards determine the average expected pay out percentage of these gaming machines. Because the outcomes of these gaming machines are randomly determined, there is no certainty that a player will ever obtain any particular available award. That is, no matter how many times a player plays the game, since the gaming machine generates outcomes randomly (such as based upon one or more probability calculations), there is no certainty that the gaming machine will ever provide the player with a specific award (such as a jackpot award). On the other hand, due to the random determinations, the gaming machine can provide a specific award (such as a jackpot award) numerous times in a small number of plays. For example, a probability-based $1 gaming machine may be programmed to payback, on average, 95% of all wagers placed with a 1% chance of generating a $10 win outcome, a 5% chance of generating a $5 win outcome, a 10% chance of generating a $2 win outcome, a 40% chance of generating a $1 win outcome and a 44% chance of generating a $0 loss outcome. However, when one hundred game outcomes are generated by the probability-based gaming machine, the actual payback may be 137% of all wagers placed and the actual generated outcomes may be six $10 win outcomes, one $5 win outcome, eighteen $2 win outcomes, thirty-six $1 win outcomes and thirty-nine $0 loss outcomes. This uncertainty is faced by both players and gaming establishments.

Regulatory agencies in certain jurisdictions (such as certain states) do not permit the use of such probability-based gaming machines, in part for these reasons. Rather, these regulatory agencies permit the use of gaming machines that are guaranteed to provide certain awards, so that, for example, a certain award is guaranteed to be provided to one of the players and the overall amount paid back to players is guaranteed. That is, the payback percentage is static and not an average expected amount.

Gaming systems that employ central determination system central servers have been implemented for such purposes. When a player plays a game on one of the gaming machines of such gaming systems, an award amount (which can be 0 credits or $0) is determined and provided by the central determination system central server to the gaming machine. The generated award amount is communicated from the central server to the individual gaming machine and the gaming machine displays an outcome that corresponds with that award amount. It should be appreciated that one central server of such a gaming system can be connected to hundreds or more individual gaming machines to provide award amounts to such gaming machines.

To comply with the above mentioned regulatory rules that do not permit the use of probability-based gaming machines, gaming systems have been implemented wherein the central server maintains one or more predetermined pools of award amounts (some of which are 0 credits or $0). In these gaming systems, when a player makes a wager on one of the gaming machines, the central server independently selects one of the available award amounts from a pool of award amounts and flags that selected award amount as used. Once an award amount is flagged as used, it is prevented from further selection from that pool and cannot be selected by the central server again. The selected award amount is communicated to the individual gaming machine. The individual gaming machine displays a game presentation that results in that award amount. Each pool is used until all of the award amounts in that pool are selected and flagged.

The following background regarding historical horse race based gaming systems is also provided for a better understanding of various embodiments of the present disclosure.

Historical horse race (“HHR”) gaming systems often look and operate somewhat similar to Class III gaming machines. However, instead of randomly generating one or more numbers that are used to determine and display the outcome (such as the displayed symbols) for each game play (and thus any award amounts for the player for the game play based on that displayed outcome), the HHR gaming system determines the outcome of each game play (and thus any award amounts for the player of the game) based on data from one or more previously run horse races (i.e., historical horse race data or HHR data).

For simplicity and ease of explanation, HHR gaming systems that determine the outcome of a game play (and thus any award amount for the game play) based on data from a single historical horse race are first described below. Thereafter, HHR gaming systems that determine the outcome of a game play (and thus any award amount for the game play) based on multiple historical horse races are then further briefly described below.

An HHR gaming system enables a player to wager on the outcome of a horse race similar to wagering at a race track or an off track betting facility; however, the difference is that the HHR gaming system enables the player to wager on an outcome of a historical horse race that was previously run (instead on an outcome of a future horse race that will be run). This configuration avoids the need for the player to wait for the future horse race to be actually run (such as when a player makes a wager for a future horse race at a race track). Rather, immediately after the player makes the wager on the historical horse race, the HHR gaming system determines the outcome for that historical horse race (which includes the order the horses finished in), displays that outcome to the player, determines any award resulting from that outcome, displays any determined award resulting from that outcome, and provides any determined award to the player. Such HHR gaming systems are legal in certain jurisdictions where traditional Class III gaming systems are not legal.

More specifically, an HHR gaming system can provide one or more of a variety of different wagering options for the player that are based on and for a historical horse race. For example, an HHR gaming system can enable the player to wager on: (1) the winning horse (by horse number or pole position) of the historical horse race; (2) an order that two horses (by horse number or pole positions) of the horse race will finish the historical horse race (such as the first and second place finishers); (3) an order that three horses (by horse number or pole positions) of the historical horse race will finish the race (such as the first, second, and third place finishers); or (4) an order that a plurality of or all of the horses (by horse number or pole positions) of the historical horse race will finish the historical horse race (such as the order that 8 or 10 horses will finish in an 8 or 10 horse race). The player selection of the order for the horses for the horse race for the player wager is often referred to as handicapping.

For such wagering options, the HHR gaming system does not display the date or location of any historical horse race, or the names of the horses or jockeys; but rather displays a handicapping form (sometimes referred to as a race set form) so that the player can input for the player wager a player selection of the wagered-on order that the horses of the horse race will finish that horse race (such as by horse number or pole position), just as they would for a live horse race.

After the HHR gaming system receives one or more player inputs corresponding to a wager by a player on a historical horse race, the HHR gaming system randomly selects a historical horse race from a library of different historical horse races stored in one or more suitable databases of the HHR gaming system or accessible by the HHR gaming system (such as 100,000 historical horse races). The HHR gaming system does not display any identifying information regarding the selected historical horse race (such as where and when the historical horse race was run or which horses and jockeys participated in the historical horse race).

The HHR gaming system can alternatively randomly select a historical horse race from the library of historical horse races for the next game play before receiving any player inputs corresponding to a wager by a player on that next game play and associated historical horse race. In such case, the HHR gaming system does not display any identifying information regarding the selected historical horse race before the player makes the wager for that game play.

After selecting the historical horse race from the database, the HHR gaming system is configured to display and thus enable the player to watch a replay of the selected historical horse race and thus see the outcome of that historical horse race (which includes the order horses finished in) if the player desires to do so. In various situations, to reduce game play time, the HHR gaming system is configured to display only a portion of the historical horse race such as the last few seconds of the historical horse race.

After selecting the historical horse race from the database, the HHR gaming system is also configured to display and thus enable the player to watch an alternative indication of the outcome of that historical horse race if the player desires to do so. For example, the HHR gaming system is configured to display and thus enable the player to watch a play of a slot game including a set of reels spinning and stopping to display an indication of the outcome for the reels (i.e., the displayed symbols on the reels) that correspond to the outcome (which includes the order the horses finished in) for that historical horse race. The outcome displayed by the reels results in the same award(s) as the outcome of that historical horse race. The award can be based on the player's wager, and the award can be zero if the outcome is not a winning outcome.

The display of the reels provides a reel type gaming machine-style entertaining way of alternatively displaying the outcome of the historical horse race. The HHR gaming system can simultaneously display the ending (such as the last few seconds) of the selected historical horse race at the same time as displaying the reels spinning and stopping. Thus, the outcome for the historical horse race and the outcome for the reels can be simultaneously displayed.

Various HHR gaming systems provide an automatic horse order selection function selectable by the player for the player wager, wherein employment of this function causes the HHR gaming system to automatically select the wagered on order of the horses for the player as part of the player's wager on the historical horse race. This function saves the player time and effort, and speeds up game play. When the player selects to employ this automatic horse order selection function, the HHR gaming system operates more like a Class III gaming machine because the player does not need to spend the time picking the individual horses or order of the horses for the player's wager for the historical horse race game play.

The odds of a player selecting (or the automatic horse order selection function selecting) any given quantity of outcomes of horse races correctly is approximately random, and therefore the odds of picking any quantity of outcomes of historical horse races correctly can be appropriately mapped to the odds of an outcome associated with a set of game symbols for a wagering game. This correlation provides a fundamental basis for HHR gaming systems.

As indicated above, an HHR gaming system can employ multiple historical horse races for a single historical horse race game play. For such an HHR gaming system, the HHR gaming system can provide a wagering option for the player that is for a plurality of historical horse races. For example, an HHR gaming system can enable the player to wager on, for each of a plurality of historical horse races, an order that all horses (by horse number or pole positions) of that historical horse race will finish the historical horse race. An HHR gaming system can provide an automatic horse order selection function selectable by the player and that causes the HHR gaming system to automatically select, for each of a plurality of historical horse races, the order of the horses for each of the plurality of historical horse races for the player as part of the player's wager on the plurality of historical horse races.

The following background regarding keno game plays and gaming systems is provided for a better understanding of various embodiments of the present disclosure.

For a play of a keno game, the gaming machine displays the play of the keno game including one or more keno cards that each include a plurality of spots arranged on a keno card. Each keno card includes 80 numbered spots arranged in an 8 row and 10 column card configuration, wherein each row includes 10 spots, and each column includes 8 spots. The spots are indicated by respective symbols such as the consecutive numbers 1 to 80.

For a play of the keno game, the gaming machine displays the play of the keno game including a player selection of a quantity of player spots for the keno card (such as two to ten spots from the plurality of spots of the keno card). These player spots of the keno card are each indicated by a player spot indicator (such as but not limited to a specific color or specific symbol). These player spots of the keno card form a player spot set for the play of the keno game. For a play of a keno game, the gaming machine enables the player to alternatively auto-pick the player spots or employ player spots selected for a previous play of the keno game (such as to speed up plays of the keno game and to make it easier for the players to play the keno game).

For a play of the keno game, the gaming machine displays the play of the keno game including a total quantity of processor randomly drawn spots for the keno card (such as 20 spots of the keno card from the 80 spots on the keno card). These drawn spots are each indicated by a drawn spot indicator (such as but not limited to a keno ball corresponding to that drawn spot). These drawn spots for the keno card form a drawn spot set for the play of the keno game.

For a play of the keno game, the gaming machine determines any award based on the quantity of matches (sometime called “hits”) between the drawn spots and the player spots for that play of the keno game. Since the gaming machine randomly determines the plurality of drawn spots, the award is therefore also randomly determined (i.e., based on the quantity of player picked spots that match the gaming machine randomly generated drawn spots).

Since the award amount for a keno game is randomly determined and the award amount for a central determination gaming system is predetermined, to implement keno games via a CD gaming system such as an HHR gaming system, the present disclosure provides gaming systems with suitable keno structures.

Additionally, since there are numerous variations of keno games such as keno games with one or more additional features, the present disclosure provides gaming systems with keno structures that are flexible enough to be implemented with any of numerous different keno game variations such as but not limited to: CAVEMAN KENO, DAVINCI DIAMONDS KENO, CLEOPATRA KENO, DREAM BALL KENO, AND ULTIMATE X KENO. Certain of these game names may be trademarked by the producer of the gaming systems providing such keno games.

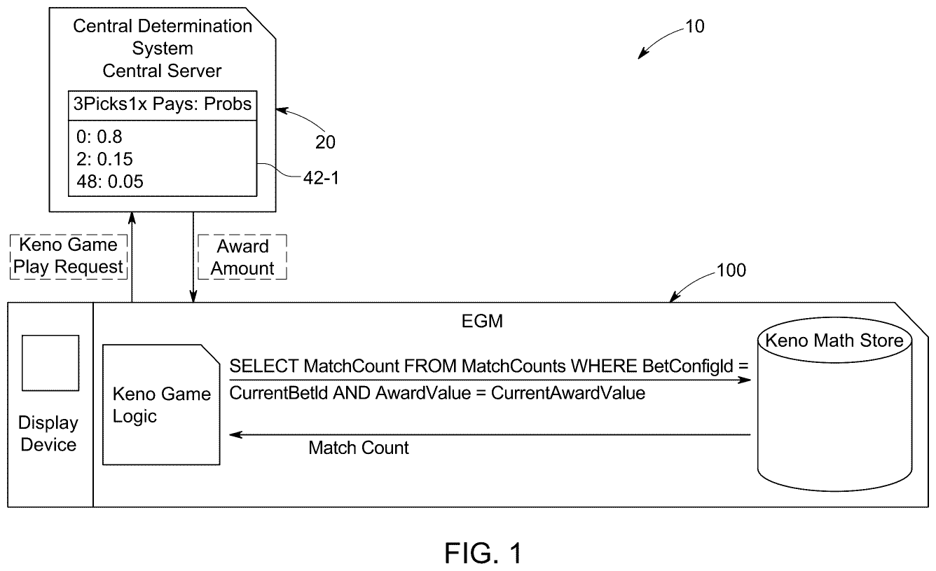

Turning now to the Figures, FIG. 1 generally illustrates a combined system and flow diagram showing one example gaming system 10 and part of the method of operating the gaming system 10 in accordance with one example embodiment of the present disclosure.

The gaming system 10 includes one or more central determination system central servers such as central determination system central server (“CDSCS”) 20 and one or more electronic gaming machines such as electronic gaming machine (“EGM”) 100. The CDSCS 20 includes one or more processors (not shown) and one or more memory devices (not shown) that store a plurality of instructions, which when executed by the processor cause the processor to cause the respective functions described herein. The EGM 100 includes one or more processors (not shown) and one or more memory devices (not shown) that store a plurality of instructions, which when executed by the processor cause the processor to cause the respective functions described herein. The processors and memory devices can be the processors and memory devices described below. The quantities of the CDSCSs and the quantities of EGMs can vary in accordance with the present disclosure. For brevity and simplicity, the keno structures for only one CDSCS and one EGM are described herein. The quantities of keno structure pool sets maintained by the CDSCS can be one or more pool sets, but for brevity and simplicity, one keno structure pool set is used herein. Additionally, since central determination systems such as the ones described above are well known in the gaming industry, such central determination systems and the central servers thereof are not further described herein for brevity and simplicity.

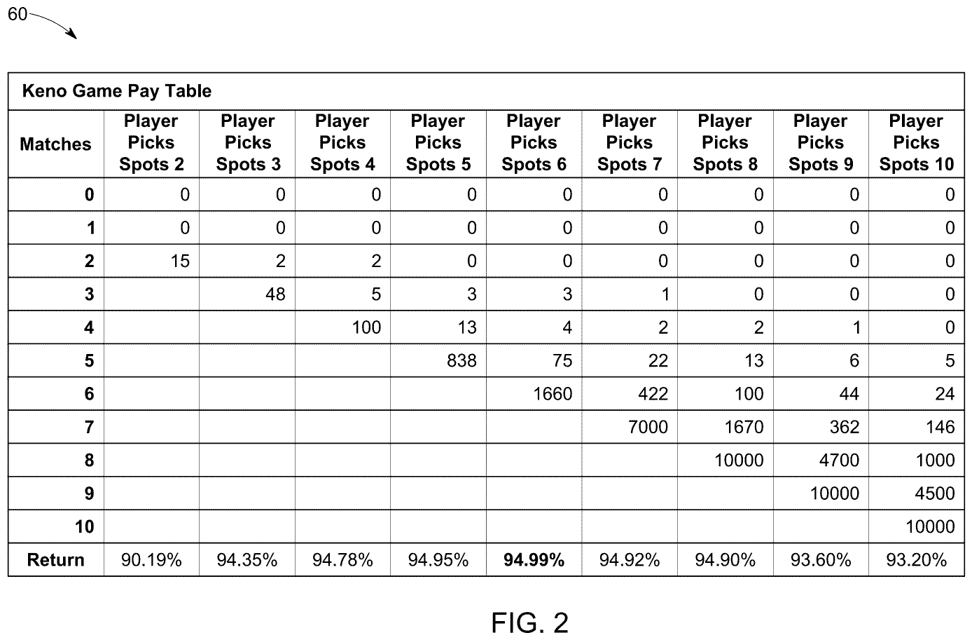

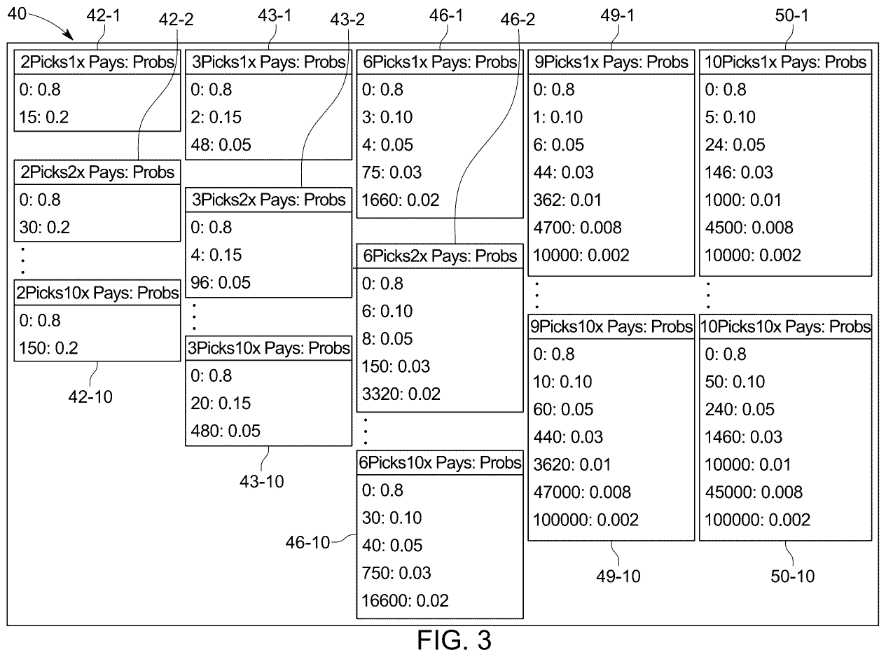

The CDSCS maintains keno structure pool set 40 shown in FIG. 3 for a keno game with a keno paytable such as the keno paytable 60 shown in FIG. 2. This keno paytable 60 shown in FIG. 2 includes the available different quantities of player picks (e.g., 2 to 10 such as described above) for the play of the keno game, the different potential quantities of player matches for the play of the keno game, the respective associated available award amounts, and the expected returns.

The CDSCS maintains the keno structure pool set 40 shown in FIG. 3 that includes a separate sub-pool for each respective different combination of the different possible player picked spot quantities and the different possible wager amounts for a play of the keno game. In this example embodiment, the player can wager 1 to 10 credits for the play of the keno game, and thus for each different credit amount, the keno structure pool set 40 includes a different sub-pool for a total of ninety sub-pools (only some of which are shown). In this example, the keno structure pool set 40 has ninety sub-pools including: (1) 10 sub-pools for 2 player picks (including illustrated example sub-pools 42-1, 42-2, and 42-10); (2) 10 sub-pools for 3 player picks (including illustrated example sub-pools 43-1, 43-2, and 43-10); (3) 10 sub-pools for 4 player picks (not shown); (4) 10 sub-pools for 5 player picks (not shown); (5) 10 sub-pools for 6 player picks (including illustrated example sub-pools 46-1, 46-2, and 46-10); (6) 10 sub-pools for 7 player picks (not shown); (7) 10 sub-pools for 8 player picks (not shown); (8) 10 sub-pools for 9 player picks (including illustrated example sub-pools 49-1 and 49-10); and (9) 10 sub-pools for 10 player picks (including illustrated example sub-pools 50-1 and 50-10). Each illustrated example sub-pool shows a plurality of different potential award amounts and the respective initial odds of that award amount being selected.

In this example, sub-pool 42-1 includes two different possible award amounts of 0 and 15 credits and respective quantities of occurrences based on associated odds of being selected which are 0.8 or 80% for the 0 award and 0.2 or 20% for the 15 credit award.

In this example, this sub-pool 42-1 thus has the following award amounts: 0, 0, 0, 0, 0, 0, 0, 0, 15, and 15. When this sub-pool is employed for a play of a keno game at the EGM 100, the CDSCS 400 randomly selects one of the possible award amounts, flags that award amount in this sub-pool 42-1 as used, and sends data indicating that award amount to the EGM 100. The EGM uses that award amount for the play of the keno game as described below. Once an award amount from a sub-pool is flagged, that award amount will be not selectable again. After all of the award amounts are selected from the sub-pool 42-1, another same sub-pool 42-1 can be implemented and employed. In other embodiments, multiple sub-pools 42-1 can be simultaneously employed. In alternative embodiments for the HHR systems, finite sub-pools may not be employed and the odds are always the same such as 80% and 20% odds in this example embodiment.

Similarly, in this example, sub-pool 42-10 includes two different possible award amounts of 0 and 150 credits and respective quantities of occurrences based on associated odds of being selected which are 0.8 or 80% for the 0 award and 0.2 or 20% for the 150 credit award.

In this example, this sub-pool 42-10 includes the following award amounts: 0, 0, 0, 0, 0, 0, 0, 0, 150, and 150. When this sub-pool is employed for a play of a keno game at the EGM 100, the CDSCS 400 randomly selects one of the possible award amounts, flags that award amount as used, and sends data indicating that award amount to the EGM 100. The EGM uses that award amount for the play of the keno game as described below. Once an award amount from a sub-pool is flagged, that award amount will be not selectable again. After all of the award amounts are selected from the sub-pool 42-10, another same sub-pool 42-10 can be implemented and employed. In other embodiments, multiple sub-pools 42-10 can be simultaneously employed. In alternative embodiments for the HHR systems, finite sub-pools may not be employed and the odds are always the same such as 80% and 20% odds in this example embodiment.

In this example, sub-pool 50-1 includes seven different possible award amounts of 0, 5, 24, 146, 1000, 4500, and 10000 credits and respective quantities of occurrences based on associated odds of being selected which are 0.8 or 80% for the 0 award, 0.1 or 10% for the 5 credit award, 0.05 or 5% for the 24 credit award, 0.03 or 3% for the 146 credit award, 0.01 or 1% for the 1000 credit award, 0.008 or 0.8% for the 4500 credit award, and 0.002 or 0.2% for the 10000 credit award.

In this example, this sub-pool 50-1 has all of the respective award amounts and when this sub-pool is employed for a play of a keno game at the EGM 100, the CDSCS 400 randomly selects one of the possible award amounts, flags that award amount in this sub-pool 50-1 as used, and sends data indicating that award amount to the EGM 100. The EGM uses that award amount for the play of the keno game as described below. Once an award amount from a sub-pool is flagged, that award amount will be not selectable again. After all of the award amounts are selected from the sub-pool 50-1, another same sub-pool 50-1 can be implemented and employed. In other embodiments, multiple sub-pools 50-1 can be simultaneously employed. In alternative embodiments for the HHR systems, finite sub-pools may not be employed and the odds are always the same.

In this example, sub-pool 50-10 includes seven different possible award amounts of 0, 50, 240, 1460, 10000, 45000, and 100000 credits and respective quantities of occurrences based on associated odds of being selected which are 0.8 or 80% for the 0 award, 0.1 or 10% for the 50 credit award, 0.05 or 5% for the 240 credit award, 0.03 or 3% for the 1460 credit award, 0.01 or 1% for the 10000 credit award, 0.008 or 0.8% for the 45000 credit award, and 0.002 or 0.2% for the 100000 credit award.

In this example, this sub-pool 50-10 has all of the respective award amounts and when this sub-pool is employed for a play of a keno game at the EGM 100, the CDSCS 400 randomly selects one of the possible award amounts, flags that award amount in this sub-pool 50-10 as used, and sends data indicating that award amount to the EGM 100. The EGM uses that award amount for the play of the keno game as described below. Once an award amount from a sub-pool is flagged, that award amount will be not selectable again. After all of the award amounts are selected from the sub-pool 50-10, another same sub-pool 50-10 can be implemented and employed. In other embodiments, multiple sub-pools 50-10 can be simultaneously employed. IS THIS CORRECT? In alternative embodiments for the HHR systems, finite sub-pools may not be employed and the odds are always the same.

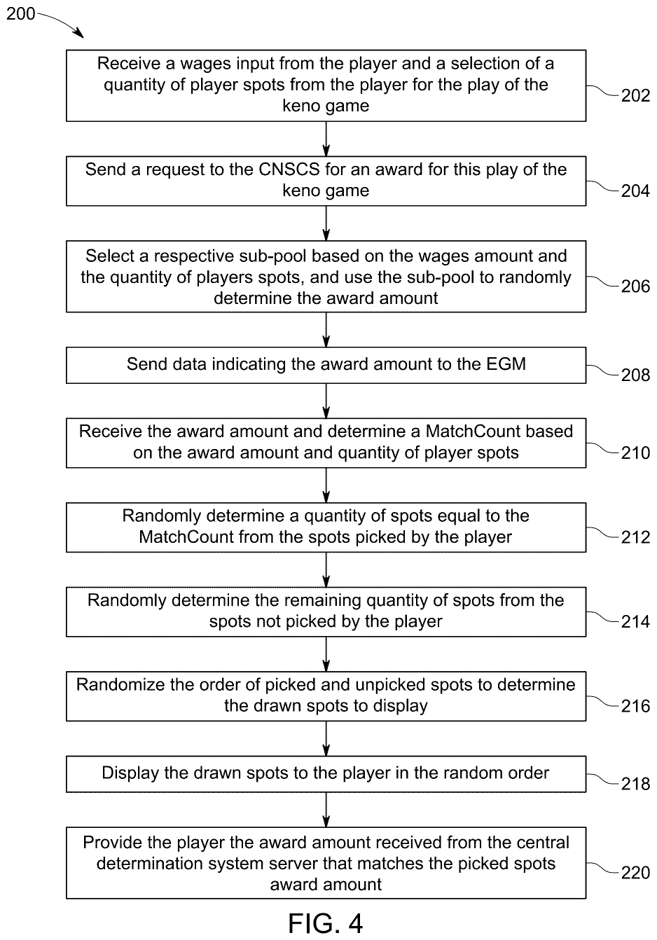

In one example embodiment, the CDSCS 20 and the EGM 100 execute the example method 200 shown in FIG. 4 to provide a play of a keno game using such a keno structure pool set. This method is represented by sets of instructions stored in the respective memories and executed by the respective processors of the CDSCS 20 and the EGM 100. Although the method is described with reference to the flow diagram shown in FIG. 4, other processes of performing the acts associated with this illustrated method can be employed. For example, the order of certain of the illustrated blocks can be changed, certain of the illustrated blocks can be optional, or certain of the illustrated blocks may not be employed.

More specifically, the EGM receives a wager input from the player and a selection of a quantity of player spots from the player for the play of the keno game, as indicated by block 202.

The EGM sends a request to the CDSCS for an award for this play of the keno game, wherein the request includes the wager amount and the quantity of player spots, as indicated by block 204.

The CDSCS selects the respective sub-pool based on the wager amount and quantity of player spots, and uses that sub-pool to randomly determine the award for this play of the keno game, as indicated by block 206.

The CDSCS sends data indicating the award amount for this play of the keno game to the EGM, as indicated by block 208.

The EGM receives the award amount and determines a MatchCount for the play of the keno game based on the award amount and the quantity of player spots, as indicated by block 210.

The EGM randomly determines a quantity of spots equal to the MatchCount from the spots picked by the player, as indicated in block 212.

The EGM randomly determines the remaining quantity of spots from the spots not picked by the player, as indicated in block 214.

The EGM randomizes the order of the picked spots and unpicked spots to determine the drawn spots to display, as indicated in block 216.

The EGM displays the drawn spots to the player in the random order, as indicated in block 218.

The EGM provides the player the award amount received from the central determination system server that matches the picked spots award amount, as indicated in block 220.

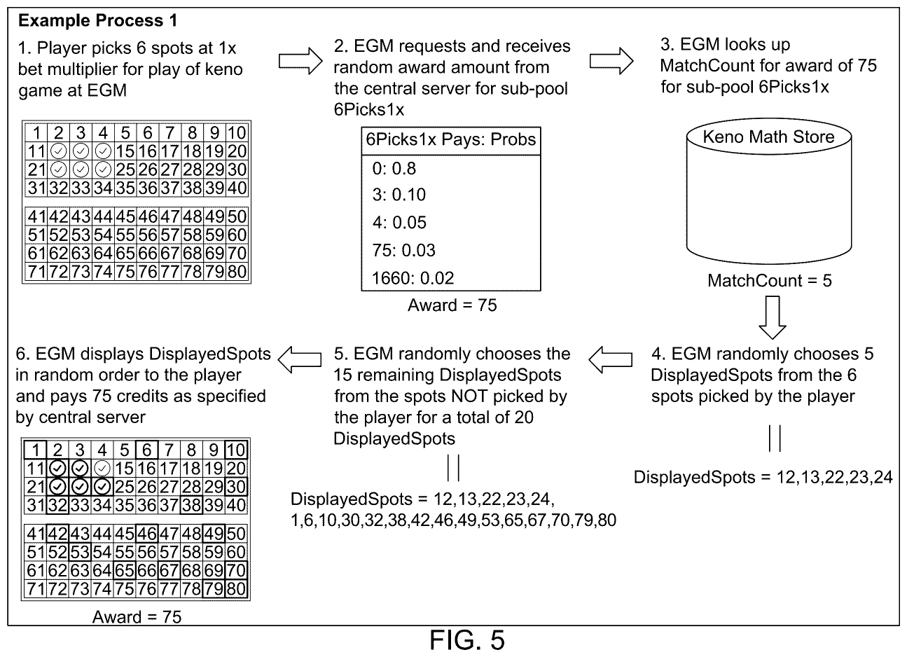

Turning now to FIG. 5, one example keno game play provided by the EGM 100 is generally illustrated. In this illustrated example, the EGM 100 enables a player to initiate a play of the keno game by making a wager of one of the plurality of different wager amounts and by selecting a respective quantity of spots from the plurality of different spots of the keno board. In this example shown in FIG. 5, the player picks 6 spots (12, 13, 14, 22, 23, and 24) of the keno board and makes a 1 credit wager (for the 1× bet multiplier).

In the example illustrated in FIG. 5, the EGM 100 sends a request to the CDSCS 20 for an award for this play of the keno game. The request includes the quantity of player picked spots and the amount of the wager. The CDSCS 20 determines which of the sub-pools to use based on the quantity of player picked spots and the amount of the wager. In this example, the CDSCS 20 uses the selected sub-pool 46-1 to randomly determine the award of 75 for this play of the keno game. The CDSCS 20 sends data indicating the award of 75 for this play of the keno game to the EGM 100.

In the example illustrated in FIG. 5, the EGM 100 uses the award of 75 and a keno math store database stored on the EGM 100 to determine a MatchCount for the award of 75 based on the 6 spot picks of the player and the 1× bet multiplier. The EGM 100 determines that the MatchCount is 5. In various embodiments, the math store database contains suitable data that enables the EGM 100 to make such determinations. This data can include, for example, MatchCount data plus any other data required to reproduce the required Keno game outcome such as the number of matches and associated award. In various embodiments, the math store database will have the data necessary to present all of the different awards that are winnable including base and bonus award. For example, if a bonus of additional free keno games is triggered, all subsequent keno games will be presented according to the keno math store such that the total pay is equal to the amount determined by the central server.

In the example illustrated in FIG. 5, the EGM 100 uses the MatchCount of 5 to select 5 of 6 player spots to be matched spots and thus DisplayedSpots. In this example, the 5 matched spots that will be DisplayedSpots are 12, 13, 22, 23, and 24. At this point, the EGM 100 does not display these DisplayedSpots.

In the example illustrated in FIG. 5, the EGM 100 randomly selects 15 remaining spots (other than any other player picked spots) to be additional DisplayedSpots for the play of the keno game. In this example, the 15 additional spots that will also be DisplayedSpots are 1, 6, 10, 30, 32, 38, 42, 46, 49, 53, 65, 67, 70, 79, and 80. At this point, the EGM 100 does not display these DisplayedSpots.

In the example illustrated in FIG. 5, the EGM 100 then displays the 20 DisplayedSpots for the play of the keno game in a random order (rather than in the order selected) such that the matching spots are mixed in with the non-matching spots.

In the example illustrated in FIG. 5, the EGM 100 then displays the quantity of matches, which in this example is 5 and the corresponding award of 75 credits (which was determined and provided by the CDSCS), provides that award of 75 credits to the player, and then ends the play of the keno game.

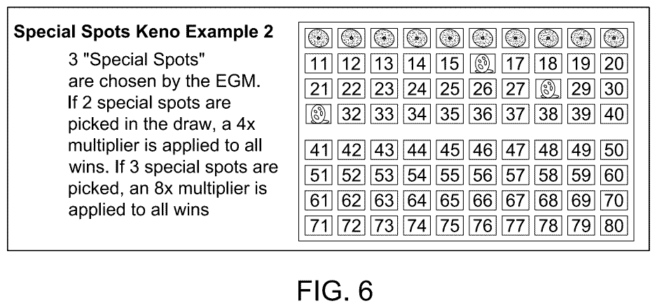

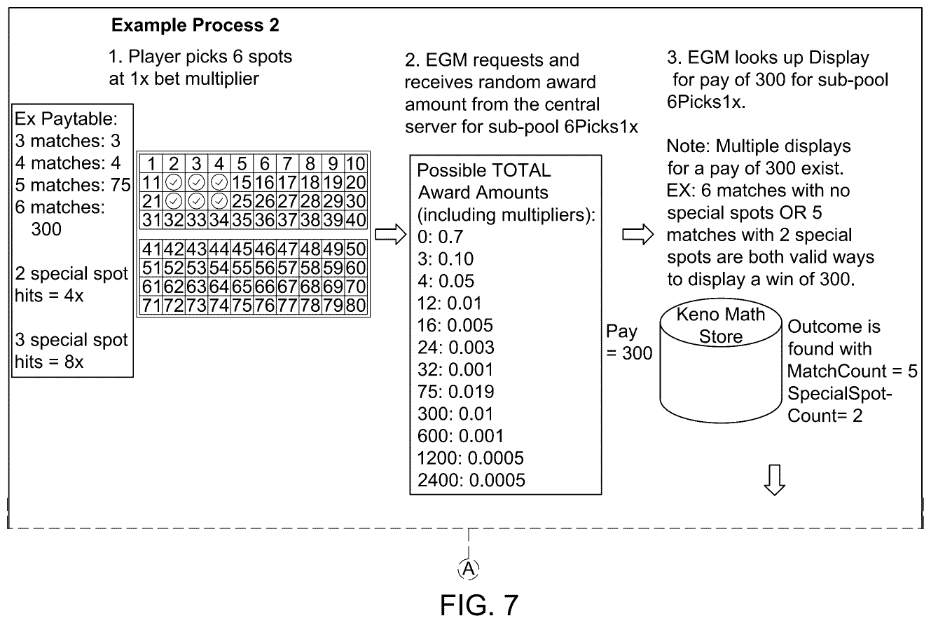

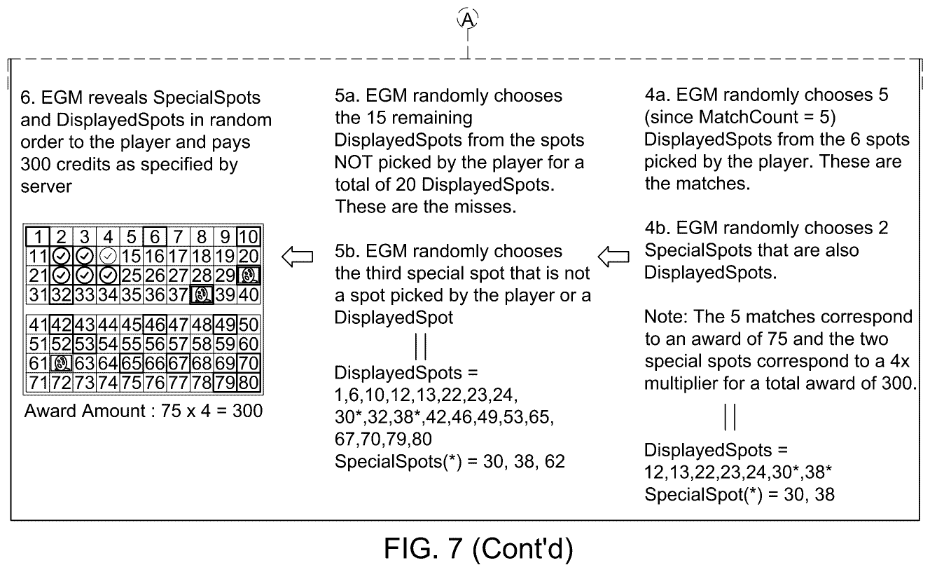

Turning now to FIGS. 6 and 7, another example keno game play that can be provided by the EGM 100 in accordance with the present disclosure is generally illustrated.

In this example as indicated in FIG. 6, the keno game is a different keno game with an additional feature. In this keno game, 3 special spots (such as indicated by the eggs in FIG. 6) are selected by the EGM. If two of those special spots match the drawn spots, the EGM applies a 4× multiplier to the award that is determined based on the quantity of matches of the player spots and drawn spots. If three of those special spots match the drawn spots, the EGM applies an 8× multiplier to the award that is determined based on the quantity of matches of the player spots and drawn spots.

In this illustrated example as indicated in FIG. 7, the EGM 100 enables a player to initiate a play of the keno game by making a wager of one of the different wager amounts and by selecting a respective quantity of spots from the plurality of different spots of the keno board. In this example shown in FIG. 7, the player picks 6 spots (12, 13, 14, 22, 23, and 24) and makes a 1 credit wager (for the 1× bet multiplier).

In the example illustrated in FIG. 7, the EGM 100 sends a request to the CDSCS 20 for an award for this play of the keno game. The request includes the quantity of player picked spots and the amount of the wager. The CDSCS 20 determines which of the sub-pools to use based quantity of player picked spots and the amount of the wager. The CDSCS 20 uses the sub-pool configured for this keno game alternative to randomly determine the award of 300 for this play of the keno game. The CDSCS 20 sends data indicating the award of 300 for this play of the keno game to the EGM 100.

In the example illustrated in FIG. 7, the EGM 100 uses the award of 300 and a keno math store database stored on the EGM 100 to determine a MatchCount for the award of 300 based on the 6 spot picks of the player and the 1× bet multiplier. In this example, there are two different ways to achieve the award of 300 as indicated in FIG. 7. Specifically, the EGM can provide six matches and no special spots or 5 matches with 2 special spots to achieve the award of 300. In this example, the EGM 100 determines to use the first way, and then determines that the MatchCount is 5 and the SpecialSpot Count is 2.

In the example illustrated in FIG. 7, the EGM 100 uses the MatchCount of 5 to select 5 of 6 player spots to be matched spots and thus DisplayedSpots. In this example, the 5 matched spots that will be DisplayedSpots are 12, 13, 22, 23, and 24 and correspond to the award of 75 for five matches. In the example illustrated in FIG. 7, the EGM 100 also selects spots 30 and 38 to be the special spots that correspond to a 4× multiplier. These special spots are also part of the DisplayedSpots as indicated in FIG. 7. At this point, the EGM 100 does not display these DisplayedSpots.

In the example illustrated in FIG. 7, the EGM 100 randomly selects 15 remaining spots (other than any other player picked spots) to be the additional DisplayedSpots for the play of the keno game. In this example, the 15 additional spots that will also be DisplayedSpots are 1, 6, 10, 30, 32, 38, 42, 46, 49, 53, 65, 67, 70, 79, and 80. In the example illustrated in FIG. 7, the EGM 100 also selects spot 62 to be the third special spot wherein this spot does not match any of the player spots. This additional special spot is also part of the DisplayedSpots as indicated in FIG. 7. At this point, the EGM 100 does not display these DisplayedSpots.

In the example illustrated in FIG. 7, the EGM 100 then displays the 20 DisplayedSpots and the 3 special spots that are also DisplayedSpots for the play of the keno game in a random order (rather than in the order selected) such that the matching spots are mixed in with the non-matching spots.

In the example illustrated in FIG. 7, the EGM 100 then displays the quantity of matches which in this example is 5, the corresponding award of 75 credits, the multiplier of 4× resulting from the special spots that match two of the player spots, and the total award of 300 (which was determined and provided by the CDSCS 20 for this play of the keno game). The EGM 100 then provides that award of 300 credits to the player and ends the play of the keno game.

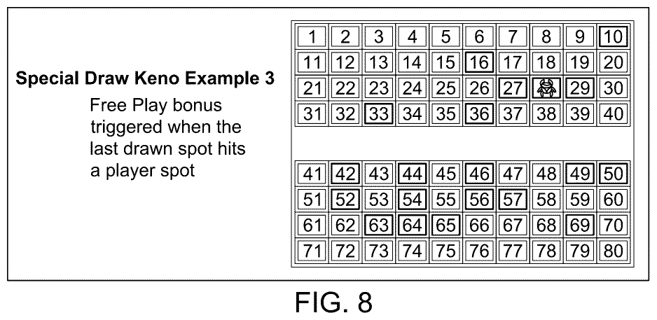

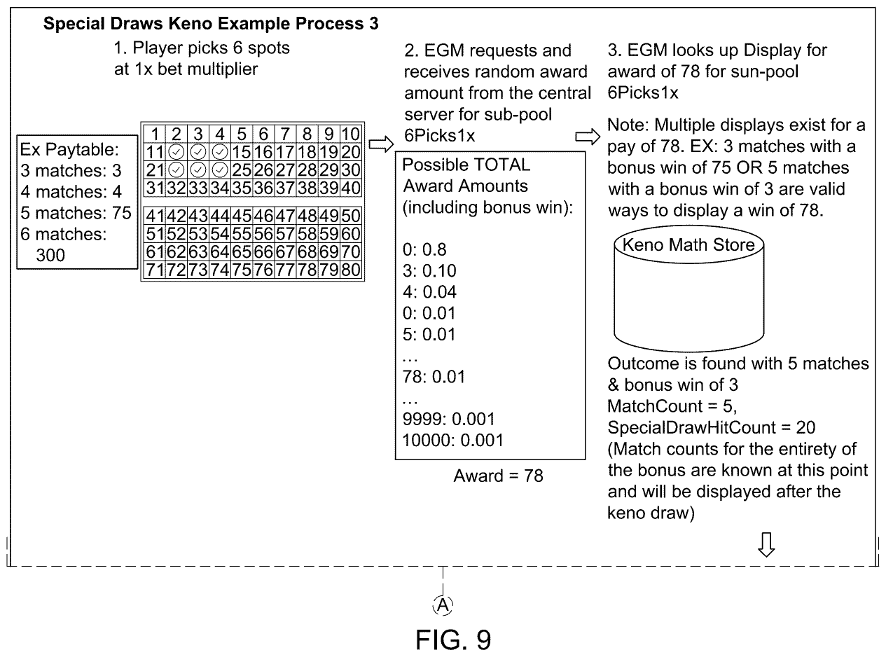

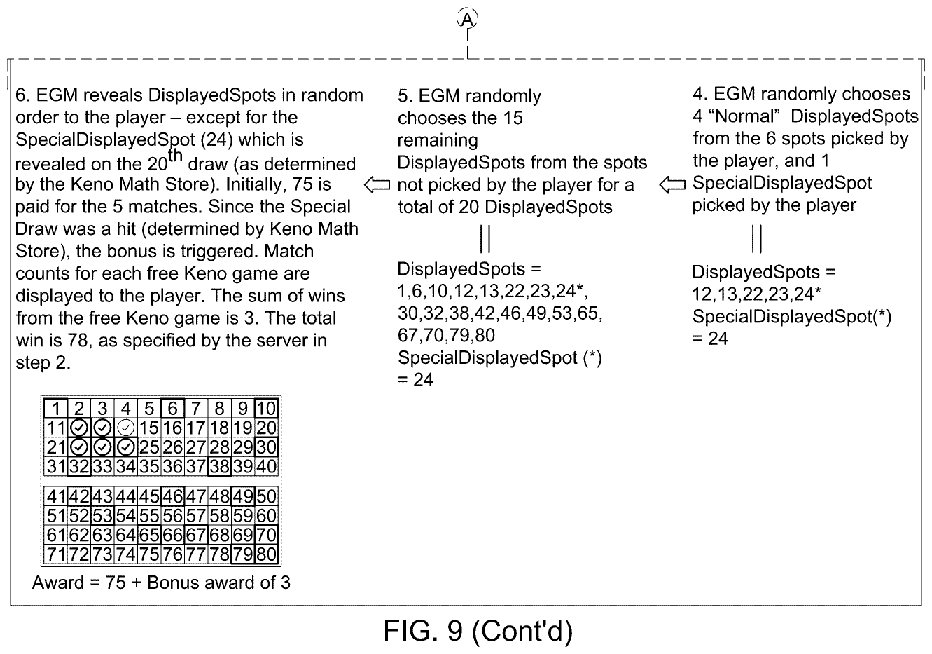

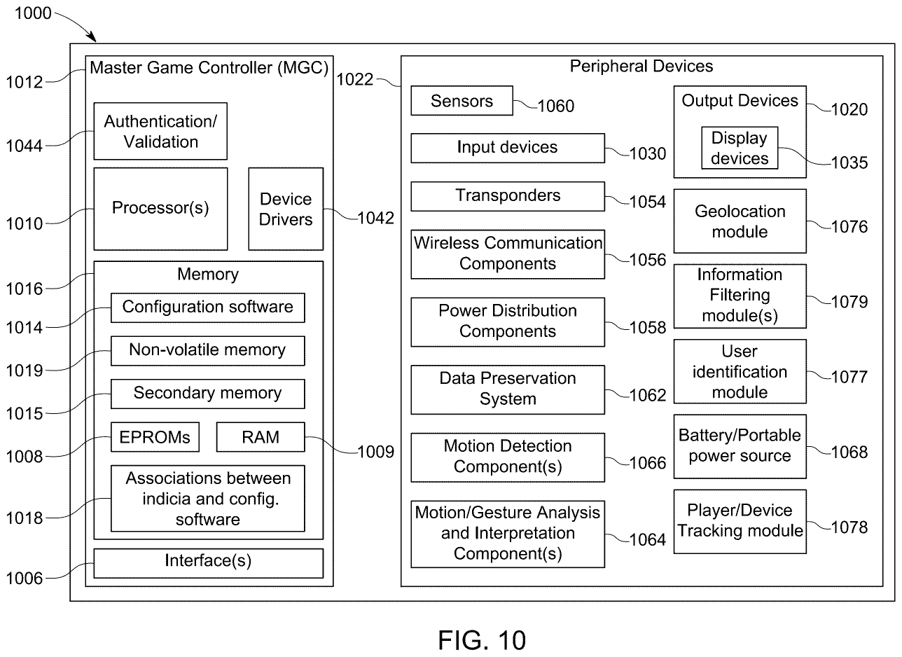

Turning now to FIGS. 8 and 9, another example keno game play that can be provided by the EGM 100 in accordance with the present disclosure is generally illustrated.

In this example as indicated in FIG. 8, the keno game is a different keno game with an additional feature. In this keno game, a free play bonus is triggered when the last drawn spot hits a player spot.

In this illustrated example as indicated in FIG. 9, the EGM 100 enables a player to initiate a play of the keno game by making a wager of one of the different wager amounts and by selecting a respective quantity of spots from the plurality of different spots of the keno board. In this example shown in FIG. 9, the player picks 6 spots (12, 13, 14, 22, 23, and 24) and makes a 1 credit wager (for the 1× bet multiplier).

In the example illustrated in FIG. 9, the EGM 100 sends a request to the CDSCS 20 for an award for this play of the keno game. The request includes the quantity of player picked spots and the amount of the wager. The CDSCS 20 determines which of the sub-pools to use based quantity of player picked spots and the amount of the wager. In this example, the CDSCS 20 uses the sub-pool configured for this keno game alternative to randomly determine the award of 78 for this play of the keno game. The CDSCS 20 sends data indicating the award of 78 for this play of the keno game to the EGM 100.

In the example illustrated in FIG. 9, the EGM 100 uses the award of 78 and a keno math store database stored on the EGM 100 to determine a MatchCount for the award of 78 based on the 6 spot picks of the player and the 1× bet multiplier. In this example, there are two different ways to achieve the award of 78 as indicated in FIG. 9. Specifically, the EGM 100 can provide three matches that results in a win of 3 and a bonus win of 75 or five matches which results in a win of 75 and a bonus win of 3 to achieve the award of 78. In this example, the EGM 100 determines to use the second way and determines that the MatchCount is 4 and the SpecialDrawHitCount is 1. The SpecialDrawHitCount which will have a value somewhere from 0 to the quantity of special draws (which either 0 or 1 in this example since there is only 1 special draw). In this example, if the SpecialDrawHitCount is 1, it would be employed by the EGM to provide the 20^{th} drawn number for this play of the keno game as a hit. This would trigger a set of free keno games that would pay a total of 3 as determined by the keno math store.

In the example illustrated in FIG. 9, the EGM 100 uses the MatchCount of 5 to select 5 of 6 player spots to be matched spots and thus DisplayedSpots. In this example, the 5 matched spots that will be DisplayedSpots are 12, 13, 22, 23, and 24 and correspond to the award of 75 for five matches. In the example illustrated in FIG. 9, the EGM 100 also selects spot 24 to be the last drawn spot and thus the SpecialDisplayedSpot. At this point, the EGM 100 does not display these DisplayedSpots.

In the example illustrated in FIG. 9, the EGM 100 randomly selects 15 remaining spots (other than any other player picked spots) to be additional DisplayedSpots for the play of the keno game. In this example, the 15 additional spots that will also be DisplayedSpots are 1, 6, 10, 30, 32, 38, 42, 46, 49, 53, 65, 67, 70, 79, and 80. At this point, the EGM 100 does not display these DisplayedSpots.

In the example illustrated in FIG. 9, the EGM 100 then displays the 20 DisplayedSpots for the play of the keno game in a random order (rather than in the order selected) such that the matching spots are mixed in with the non-matching spots, and except for the last spot which is spot that functions as the SpecialDisplayedSpot.

In the example illustrated in FIG. 9, the EGM 100 then displays the quantity of matches which in this example is 5 and the corresponding award of 75 credits, and the indication that the bonus has been triggered. The EGM 100 then provides the bonus and indicates the award of 3 from the bonus. The EGM 100 then provides the total award of 78 (which was determined and provided by the CDSCS), provides that award of 78 credits to the player, and ends the play of the keno game.

Various embodiments of the present disclosure thus provide a central determination system for determining the awards for plays of a keno game that can be any suitable keno game such as a standard EGM provided video based keno game or a variation of a keno game with one or more additional features.

Various embodiments of the present disclosure also provide HHR central determination systems for determining the awards for plays of a keno game that can be any suitable keno game such as a standard EGM provided video based keno game or a variation of a keno game with one or more additional features.

In various embodiments, for the HHR central determination system, after receiving a request from the EGM for an award for a play of a keno game, the HHR central determination system selects a historical horse race from the database, and provides the award amount and race data to the EGM. Since the probability of correctly choosing any given set of historical horse race finish orders can be matched to any desired award probability, the historical horse race sets can be mapped to different awards accordingly. Based on how the player picks the horse race set finishers (which is likely to be auto-picked for the player at the request of the player), the system will determine the award won by the player and then use that determination as described above.

The EGM is configured to use the award amount in the same manner as described above and is also configured to display and thus enable the player to watch the historical horse race or part thereof if the player desires to do so. For example, the EGM is configured to display and thus enable the player to watch the play of the keno game such as described above that corresponds to the award determined by the order the horses finished in that historical horse race. The matches displayed by the keno game results in the same award as determined based on the historical horse race.

It should be appreciated from the above that various embodiments of the present disclosure provide a gaming system comprising an electronic gaming machine configured to communicate with a central determination system central server, wherein the electronic gaming machine comprises a display device and is configured to: (1) cause a display, by the display device, of a keno board comprising a first quantity of spots, (2) cause a display, by the display device, of indications of a second quantity of player spots, the second quantity being less than the first quantity, (3) cause a display, by the display device, of an indication of a first amount associated with the second quantity of player spots, the first amount being one of a plurality of different possible amounts, (4) receive data indicating a first award amount from the central determination system central server, the first award amount selected by the central determination system central server from a first sub-pool associated with the second quantity and the first amount, the first sub-pool comprising a plurality of different award amounts comprising the first award amount and a different second award amount, (5) based on the first award amount, determine a third quantity of spots that each match a different one of the second quantity of player spots, (6) based on the first award amount, determine a fourth quantity of spots that do not match any of the second quantity of player spots, (7) cause a display, by the display device, of indications of each of the third quantity of spots and the fourth quantity of spots as drawn spots, and (8) cause a display, by the display device, of an indication of the award amount based on the drawn spots and the player spots. In various such embodiments, the award amount is the first award amount. In various such embodiments, the award amount is based on the third quantity of spots. In various such embodiments, the award amount is based on the third quantity of spots and an additional feature. In various such embodiments, the quantity of the plurality of different award amounts in the sub-pool is based on the first amount associated with the second quantity of player spots. In various such embodiments, the electronic gaming machine is configured to cause the display, by the display device, of the indications of each of the third quantity of spots and the fourth quantity of spots as drawn spots in a randomly determined order. In various such embodiments, the electronic gaming machine is configured to cause the display, by the display device, of the indications of a plurality of the third quantity of spots and each of the fourth quantity of spots as drawn spots in a randomly determined order. In various such embodiments, the electronic gaming machine is configured to cause the display, by the display device, of the indication of one of the third quantity of spots as a drawn spot in a pre-determined order.

It should further be appreciated from the above that various embodiments of the present disclosure provide a gaming system comprising an electronic gaming machine and a central determination system central server. The electronic gaming machine is configured to: (1) cause a display, by a display device thereof, of a keno board comprising a first quantity of spots, (2) cause a display, by the display device, of indications of a second quantity of player spots, the second quantity being less than the first quantity, and (3) cause a display, by the display device, of an indication of a first amount associated with the second quantity of player spots, the first amount being one of a plurality of different possible amounts. The central determination system central server is configured to: (a) receive data indicating the second quantity and the first amount from the electronic gaming machine, (b) determine a first award amount selected from a first sub-pool associated with the second quantity and the first amount, the first sub-pool comprising a plurality of different award amounts including the first award amount and a different second award amount, and (c) send data indicating the first award amount to the electronic gaming machine. The electronic gaming machine is then configured to: (4) based on the first award amount, determine a third quantity of spots that each match a different one of the player spots, (5) determine a fourth quantity of spots that do not match any of the player spots, (6) cause a display, by the display device, of an indication of the each of the third quantity of spots and the fourth quantity of spots, and (7) cause a display, by the display device, of an indication of the first award amount. In various such embodiments, the indication of the first award amount is based on the third quantity of spots that match the player spots. In various such embodiments, the indications of the first award amount is based on the third quantity of spots that match the player spots and an additional feature. In various such embodiments, the quantity of the plurality of different award amounts in the sub-pool is based on the first amount associated with the second quantity of player spots. In various such embodiments, the electronic gaming machine is configured to cause the display, by the display device, of the indications of each of the third quantity of spots and the fourth quantity of spots as drawn spots in a randomly determined order. In various such embodiments, the electronic gaming machine is configured to cause the display, by the display device, of the indications of a plurality of the third quantity of spots and each of the fourth quantity of spots as drawn spots in a randomly determined order. In various such embodiments, the electronic gaming machine is configured to cause the display, by the display device, of the indication of one of the third quantity of spots as a drawn spot in a pre-determined order.

It should further be appreciated from the above that various embodiments of the present disclosure provide a gaming system comprising a central server configured to communicate with an electronic gaming machine, wherein the central server is configured to: (1) receive data from the electronic gaming machine indicating: (a) a second quantity of player spots of a keno board selected from a first quantity of player spots of the keno board, the first quantity being greater than the second quantity, and (b) a first amount associated with the second quantity of player spots; (2) select a first sub-pool from a plurality of different sub-pools, where each of the sub-pools is associated with a different combination of quantity of player spots and an associated amount, wherein the first sub-pool is associated with the second quantity and the first amount; (3) determine a first award amount selected from the first sub-pool, the first sub-pool comprising a plurality of different award amounts including the first award amount and a different second award amount; and (4) send data indicating the first award amount to the electronic gaming machine to enable the electronic gaming machine to: (i) based on the first award amount, determine a third quantity of spots that each match a different one of the player spots, (ii) determine a fourth quantity of spots that do not match any of the player spots, (iii) cause a display, by a display device of the electronic gaming machine, of an indication of each of the third quantity of spots and the fourth quantity of spots, and (iv) cause a display, by the display device of the electronic gaming machine, of an indication of the first award amount. In various such embodiments, the indication of the first award amount is based on the third quantity of spots that match the player spots. In various such embodiments, the indications of the first award amount is based on the third quantity of spots that match the player spots and an additional feature. In various such embodiments, the display, by the display device, of the indications of each of the third quantity of spots and the fourth quantity of spots is in a randomly determined order. In various such embodiments, the display, by the display device, of the indications of a plurality of the third quantity of spots and each of the fourth quantity of spots as drawn spots is in a randomly determined order.

Thus, the keno gaming systems and methods of the present disclosure provide numerous plays of a keno game that feel completely like playing currently known keno games in which the results are completely randomly determined.

### Gaming Systems

It should be appreciated that the present disclosure contemplates a variety of different systems each having one or more of a plurality of different features, attributes, or characteristics.

A “system” as used herein refers to various configurations of: (a) one or more servers; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Thus, in various embodiments, the system of the present disclosure includes: (a) one or more electronic gaming machines in combination with one or more servers; (b) one or more personal gaming devices in combination with one or more servers; (c) one or more personal gaming devices in combination with one or more electronic gaming machines; (d) one or more personal gaming devices, one or more electronic gaming machines, and one or more servers in combination with one another; (e) a single electronic gaming machine; (f) a plurality of electronic gaming machines in combination with one another; (g) a single personal gaming device; (h) a plurality of personal gaming devices in combination with one another; (i) a single server; and/or (j) a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, and “server” as used herein represents one server or a plurality of servers.

As noted above, in various embodiments, the system includes an EGM (or personal gaming device) in combination with a server. In such embodiments, the EGM (or personal gaming device) is configured to communicate with the server through a data network or remote communication link. In certain such embodiments, the EGM (or personal gaming device) is configured to communicate with another EGM (or personal gaming device) through the same data network or remote communication link or through a different data network or remote communication link. For example, the system includes a plurality of EGMs that are each configured to communicate with a server through a data network.

In certain embodiments in which the system includes an EGM (or personal gaming device) in combination with a server, the server is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the server. The at least one processor of that EGM (or personal gaming device) is configured to execute the events, messages, or commands represented by such data or signals in conjunction with the operation of the EGM (or personal gaming device). Moreover, the at least one processor of the server is configured to transmit and receive data or signals representing events, messages, commands, or any other suitable information between the server and the EGM (or personal gaming device). The at least one processor of the server is configured to execute the events, messages, or commands represented by such data or signals in conjunction with the operation of the server. One, more than one, or each of the functions of the server may be performed by the at least one processor of the EGM (or personal gaming device). Further, one, more than one, or each of the functions of the at least one processor of the EGM (or personal gaming device) may be performed by the at least one processor of the server.

In certain such embodiments, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the system includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the system includes: (a) an EGM (or personal gaming device) configured to communicate with a server through a data network; and/or (b) a plurality of EGMs (or personal gaming devices) configured to communicate with one another through a data network, the data network is a local area network (LAN) in which the EGMs (or personal gaming devices) are located substantially proximate to one another and/or the server. In one example, the EGMs (or personal gaming devices) and the server are located in a gaming establishment or a portion of a gaming establishment.

In other embodiments in which the system includes: (a) an EGM (or personal gaming device) configured to communicate with a server through a data network; and/or (b) a plurality of EGMs (or personal gaming devices) configured to communicate with one another through a data network, the data network is a wide area network (WAN) in which one or more of the EGMs (or personal gaming devices) are not necessarily located substantially proximate to another one of the EGMs (or personal gaming devices) and/or the server. For example, one or more of the EGMs (or personal gaming devices) are located: (a) in an area of a gaming establishment different from an area of the gaming establishment in which the server is located; or (b) in a gaming establishment different from the gaming establishment in which the server is located. In another example, the server is not located within a gaming establishment in which the EGMs (or personal gaming devices) are located. In certain embodiments in which the data network is a WAN, the system includes a server and an EGM (or personal gaming device) each located in a different gaming establishment in a same geographic area, such as a same city or a same state. Systems in which the data network is a WAN are substantially identical to systems in which the data network is a LAN, though the quantity of EGMs (or personal gaming devices) in such systems may vary relative to one another.

In further embodiments in which the system includes: (a) an EGM (or personal gaming device) configured to communicate with a server through a data network; and/or (b) a plurality of EGMs (or personal gaming devices) configured to communicate with one another through a data network, the data network is an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM (or personal gaming device), such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM (or personal gaming device).

The server and the EGM (or personal gaming device) are configured to connect to the data network or remote communications link in any suitable manner. In various embodiments, such a connection is accomplished via a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

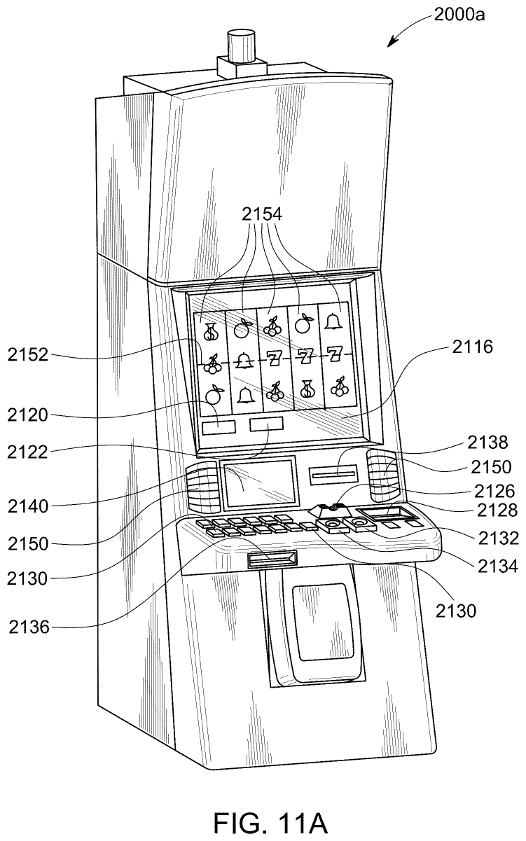

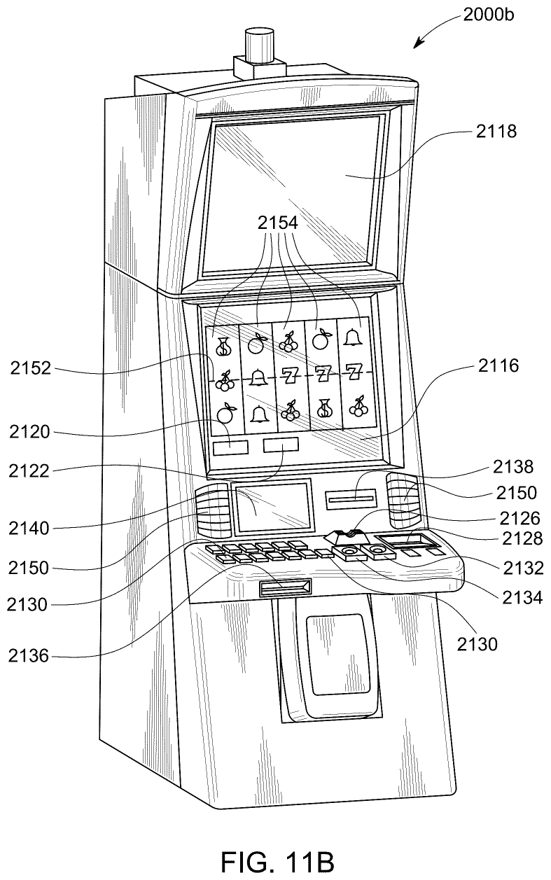

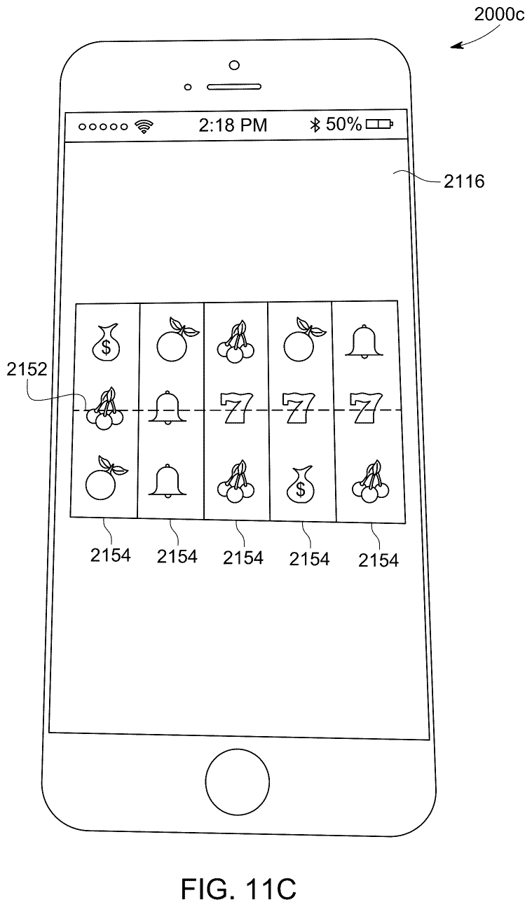

FIG. 11 is a block diagram of an example EGM 1000 and FIGS. 11A and 11B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 11C) may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM disclosed herein. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 11A includes a central display device 2116, a player tracking display 2140, a credit display 2120, and a bet display 2122. The example EGM 2000b illustrated in FIG. 11B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 11A and 11B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 11A and 11B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 11A and 11B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 11A and 11B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 11A and 11B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 11A and 11B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 11A and 11B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 11A and 11B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 11A and 11B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all systems, and these example EGMs may not include one or more elements that are included in other systems. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any alternative gaming presentations displayed as primary or base games (referred to herein as “primary games”) and/or any alternative gaming presentations displayed as any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any alternative gaming presentations displayed as any primary games and/or any alternative gaming presentations displayed as secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the system includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, as an alternative to utilizing a pool of win amounts to select one or more win amounts for a winning wager on a historical horse race, the system determines a win amount for a winning wager on a historical horse race based on the results of a bingo, keno, or lottery game. In certain such embodiments, the system utilizes one or more bingo, keno, or lottery games to determine the win amount for a winning wager on a historical horse race. The system is provided or associated with a bingo card. Each bingo card consists of a matrix or array of elements, wherein each element is designated with separate indicia. After a bingo card is provided, the system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, the win amount is determined based, at least in part, on the selected elements on the provided bingo cards.

In certain embodiments in which the system includes a server and an EGM, the EGM is configured to communicate with the server for monitoring purposes only. In such embodiments, the EGM determines the game outcome(s) and/or award(s) to be provided in any of the manners described above, and the server monitors the activities and events occurring on the EGM. In one such embodiment, the system includes a real-time or online accounting and gaming information system configured to communicate with the server. In this embodiment, the accounting and gaming information system includes: (a) a player database configured to store player profiles, (b) a player tracking module configured to track players (as described below), and (c) a credit system configured to provide automated transactions.

As noted above, in various embodiments, the system includes one or more executable game programs executable by at least one processor of the system to provide one or more primary games and one or more secondary games. The primary game(s) and the secondary game(s) may comprise any suitable games and/or wagering games, such as, but not limited to electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the system. In certain such embodiments, the system includes one or more paylines associated with the reels. The example EGM 2000b shown in FIG. 11B includes a payline 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The system enables a wager to be placed on one or more of such paylines to activate such paylines. In other embodiments in which one or more paylines are formed between at least two adjacent symbol display areas, the system enables a wager to be placed on a plurality of symbol display areas, which activates those symbol display areas.

In various embodiments, the system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the system includes a progressive award. Typically, a progressive award includes an initial amount and an additional amount funded through a portion of each wager placed to initiate a play of a primary game. When one or more triggering events occurs, the system provides at least a portion of the progressive award. After the system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the system automatically provides or initiates the secondary game upon the occurrence of a triggering event or the satisfaction of a qualifying condition. In other embodiments, the system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the system determines when to provide one or more plays of one or more secondary games with no apparent reason provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, which is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments'entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the system includes one or more player tracking systems. Such player tracking systems enable operators of the system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the system to begin a gaming session, the card reader reads the player identification number off the player tracking card to identify the player. The system timely tracks any suitable information or data relating to the identified player's gaming session. The system also timely tracks when the player tracking card is removed to conclude play for that gaming session. In another embodiment, rather than requiring insertion of a player tracking card into the card reader, the system utilizes one or more portable devices, such as a mobile phone, a radio frequency identification tag, or any other suitable wireless device, to track when a gaming session begins and ends. In another embodiment, the system utilizes any suitable biometric technology or ticket technology to track when a gaming session begins and ends.

In such embodiments, during one or more gaming sessions, the system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the system includes one or more servers configured to communicate with a personal gaming device—such as a smartphone, a tablet computer, a desktop computer, or a laptop computer—to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a predetermined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique username and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players'account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the system includes an EGM configured to communicate with a personal gaming device—such as a smartphone, a tablet computer, a desktop computer, or a laptop computer—to enable tethered mobile game play using the personal gaming device. Generally, in these embodiments, the EGM establishes communication with the personal gaming device and enables the player to play games on the EGM remotely via the personal gaming device. In certain embodiments, the system includes a geo-fence system that enables tethered game play within a particular geographic area but not outside of that geographic area.

In certain embodiments, the system is configured to communicate with a social network server that hosts or partially hosts a social networking website via a data network (such as the Internet) to integrate a player's gaming experience with the player's social networking account. This enables the system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the system to receive certain information from the social network server, such as the player's likes or dislikes or the player's list of connections. In certain embodiments, the system enables the player to link the player's player account to the player's social networking account(s). This enables the system to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the system enables the player to recommend a game to the player's connections by posting a recommendation to the player's wall (or other suitable area) of the social networking website.

Certain of the systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria can be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, BIOS, Extended BIOS, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a,” “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The claims are as follows:

1. A gaming system comprising:
an electronic gaming machine configured to communicate with a central determination system central server;
the electronic gaming machine comprising a display device, a processor, and a memory device that stores a plurality of instructions that, when executed by the processor, cause the processor to:
cause a display, by the display device, of a keno board comprising a first quantity of spots,
cause a display, by the display device, of indications of a second quantity of player spots, the second quantity being less than the first quantity,
cause a display, by the display device, of an indication of a first amount associated with the second quantity of player spots, the first amount being one of a plurality of different possible amounts,
receive data indicating a first award amount from the central determination system central server, the first award amount selected by the central determination system central server from a first sub-pool associated with the second quantity and the first amount, the first sub-pool comprising a plurality of different award amounts comprising the first award amount and a different second award amount,
based on the first award amount, determine a third quantity of spots that each match a different one of the second quantity of player spots,
based on the first award amount, determine a fourth quantity of spots that do not match any of the second quantity of player spots,
cause a display, by the display device, of indications of each of the third quantity of spots and the fourth quantity of spots as drawn spots, and
cause a display, by the display device, of an indication of the award amount based on the drawn spots and the player spots.

2. The gaming system of claim 1, wherein the award amount is the first award amount.

3. The gaming system of claim 1, wherein the award amount is based on the third quantity of spots.

4. The gaming system of claim 1, wherein the award amount is based on the third quantity of spots and an additional feature.

5. The gaming system of claim 1, wherein the quantity of the plurality of different award amounts in the sub-pool is based on the first amount associated with the second quantity of player spots.

6. The gaming system of claim 1, wherein the plurality of instructions, when executed by the processor, cause the processor to cause the display, by the display device, of the indications of each of the third quantity of spots and the fourth quantity of spots as drawn spots in a randomly determined order.

7. The gaming system of claim 1, wherein the plurality of instructions, when executed by the processor, cause the processor to cause the display, by the display device, of the indications of a plurality of the third quantity of spots and each of the fourth quantity of spots as drawn spots in a randomly determined order.

8. The gaming system of claim 1, wherein the plurality of instructions, when executed by the processor, cause the processor to cause the display, by the display device, of the indication of one of the third quantity of spots as a drawn spot in a pre-determined order.

9. A gaming system comprising:
an electronic gaming machine comprising a display device, a processor, and a memory device that stores a plurality of instructions that, when executed by the processor, cause the processor to:
cause a display, by the display device, of a keno board comprising a first quantity of spots,
cause a display, by the display device, of indications of a second quantity of player spots, the second quantity being less than the first quantity, and
cause a display, by the display device, of an indication of a first amount associated with the second quantity of player spots, the first amount being one of a plurality of different possible amounts;
a central determination system central server comprising a processor and a memory device that stores a plurality of instructions that, when executed by the processor, cause the processor to:
receive data indicating the second quantity and the first amount from the electronic gaming machine,
determine a first award amount selected from a first sub-pool associated with the second quantity and the first amount, the first sub-pool comprising a plurality of different award amounts including the first award amount and a different second award amount, and
send data indicating the first award amount to the electronic gaming machine;
wherein the plurality of instructions stored by the memory device of the electronic gaming machine, when executed by the processor of the electronic gaming machine, cause the processor of the electronic gaming machine to:
based on the first award amount, determine a third quantity of spots that each match a different one of the player spots,
determine a fourth quantity of spots that do not match any of the player spots,
cause a display, by the display device, of an indication of the each of the third quantity of spots and the fourth quantity of spots, and
cause a display, by the display device, of an indication of the first award amount.

10. The gaming system of claim 9, wherein the indication of the first award amount is based on the third quantity of spots that match the player spots.

11. The gaming system of claim 9, wherein the indications of the first award amount is based on the third quantity of spots that match the player spots and an additional feature.

12. The gaming system of claim 9, wherein the quantity of the plurality of different award amounts in the sub-pool is based on the first amount associated with the second quantity of player spots.

13. The gaming system of claim 9, wherein the plurality of instructions, when executed by the processor, cause the processor to cause the display, by the display device, of the indications of each of the third quantity of spots and the fourth quantity of spots as drawn spots in a randomly determined order.

14. The gaming system of claim 9, wherein the plurality of instructions, when executed by the processor, cause the processor to cause the display, by the display device, of the indications of a plurality of the third quantity of spots and each of the fourth quantity of spots as drawn spots in a randomly determined order.

15. The gaming system of claim 14, wherein the plurality of instructions, when executed by the processor, cause the processor to cause the display, by the display device, of the indication of one of the third quantity of spots as a drawn spot in a pre-determined order.

16. A gaming system comprising:
a central server configured to communicate with an electronic gaming machine;
the central server comprising a processor and a memory device that stores a plurality of instructions that, when executed by the processor, cause the processor to:
receive data from the electronic gaming machine indicating:
a second quantity of player spots of a keno board selected from a first quantity of player spots of the keno board, the first quantity being greater than the second quantity, and
a first amount associated with the second quantity of player spots,
select a first sub-pool from a plurality of different sub-pools, where each of the sub-pools is associated with a different combination of quantity of player spots and an associated amount, wherein the first sub-pool is associated with the second quantity and the first amount,
determine a first award amount selected from the first sub-pool, the first sub-pool comprising a plurality of different award amounts including the first award amount and a different second award amount, and
send data indicating the first award amount to the electronic gaming machine to enable the electronic gaming machine to:
based on the first award amount, determine a third quantity of spots that each match a different one of the player spots,
determine a fourth quantity of spots that do not match any of the player spots,
cause a display, by a display device of the electronic gaming machine, of an indication of each of the third quantity of spots and the fourth quantity of spots, and
cause a display, by the display device of the electronic gaming machine, of an indication of the first award amount.

17. The gaming system of claim 16, wherein the indication of the first award amount is based on the third quantity of spots that match the player spots.

18. The gaming system of claim 16, wherein the indications of the first award amount is based on the third quantity of spots that match the player spots and an additional feature.

19. The gaming system of claim 16, wherein the display, by the display device, of the indications of each of the third quantity of spots and the fourth quantity of spots is in a randomly determined order.

20. The gaming system of claim 16, wherein the display, by the display device, of the indications of a plurality of the third quantity of spots and each of the fourth quantity of spots as drawn spots is in a randomly determined order.
